(19) United States
(12) Patent Application Publication
(10) Pub. No.: US 2026/0057489 A1
(43) Pub. Date: Feb. 26, 2026

(54) METHOD AND APPARATUS FOR GENERATING IMAGE, DEVICE, AND PRODUCT

(71) Applicant: Beijing Zitiao Network Technology Co., Ltd., Beijing (CN)

(72) Inventors: Hang Dong, Beijing (CN); Qingji Dong, Beijing (CN)

(21) Appl. No.: 19/277,731

(22) Filed: Jul. 23, 2025

(30) Foreign Application Priority Data
Aug. 21, 2024 (CN) 202411155256.X

(51) Int. Cl. G06T 5/60; G06T 3/4046; G06T 3/4053; G06T 7/00; G06V 40/16

(52) U.S. Cl. CPC G06T 5/60; G06T 3/4046; G06T 3/4053; G06T 7/0002; G06T 2207/20081; G06T 2207/30168; G06T 2207/30201; G06V 40/161

(57) ABSTRACT

Embodiments of the present disclosure relate to a method and apparatus for generating an image, an electronic device, and a product. The method includes: determining super-resolution parameters for a first image based on image parameters, and output resolution that is specified by a user, where the image parameters are determined based on the first image. The method further includes: generating, by a generative super-resolution model, a second image based on the super-resolution parameters. The method further includes: generating a third image based on the output resolution and the second image, where resolution of the third image is greater than resolution of the first image.

### CROSS-REFERENCE TO RELATED APPLICATION(S)

This application claims priority to Chinese Application No. 202411155256.X filed Aug. 21, 2024, the disclosure of which is incorporated herein by reference in its entireties.

### FIELD

The present disclosure generally relates to the field of computers, and more particularly, to a method and apparatus for generating an image, an electronic device, and a program product.

### BACKGROUND

Image resolution enhancement (usually referred to as super-resolution) is an image processing technology that is designed to generate an image with higher resolution (HR) from a low-resolution (LR) image. This technology is crucial to the improvement of image quality and details, especially in fields requiring high-definition images, such as digital photography, video processing, and medical imaging.

The core challenge of a super-resolution technology is how to effectively reconstruct missing details while ensuring that the authenticity of an image is not compromised. In recent years, with the development of deep learning, learning-based approaches have become the mainstream direction of super-resolution research, especially in the application of convolutional neural networks (CNNs) and generative adversarial networks (GANs). These models can learn a mapping relationship between a low-resolution image and a high-resolution image through a large amount of training data, to generate a more realistic and clearer image.

### SUMMARY

Embodiments of the present disclosure provide a method and an apparatus for generating an image, an electronic device, and a product.

According to a first aspect of the present disclosure, there is provided a method for generating an image. The method includes: determining super-resolution parameters for a first image based on image parameters, and output resolution that is specified by a user, where the image parameters are determined based on the first image. The method further includes: generating, by a generative super-resolution model, a second image based on the super-resolution parameters. The method further includes: generating a third image based on the output resolution and the second image, where resolution of the third image is greater than resolution of the first image.

According to a second aspect of the present disclosure, there is provided an apparatus for generating an image. The apparatus includes a super-resolution parameter determination module configured to determine super-resolution parameters for a first image based on image parameters, and output resolution that is specified by a user, where the image parameters are determined based on the first image. The apparatus further includes a second image generation module configured to generate, by a generative super-resolution model, a second image based on the super-resolution parameters. The apparatus further includes a third image generation module configured to generate a third image based on the output resolution and the second image, where resolution of the third image is greater than resolution of the first image.

According to a third aspect of the present disclosure, there is provided an electronic device. The electronic device includes a processor and a memory coupled to the processor, where the memory has stored therein instructions that, when executed by the processor, cause the electronic device to perform the method according to the first aspect.

According to a fourth aspect of the present disclosure, there is provided a computer program product having stored thereon computer-executable instructions, where the computer-executable instructions are executed by a processor to implement the method according to the first aspect.

The section Summary is provided to introduce a selection of concepts in a simplified form, which will be further described in the detailed description below. The section Summary is neither intended to identify key features or principal features of the claimed subject matter, nor to limit the scope of the claimed subject matter.

### BRIEF DESCRIPTION OF THE DRAWINGS

The foregoing and other features, advantages and aspects of embodiments of the present disclosure become more apparent with reference to the following detailed description and in conjunction with the accompanying drawings. Throughout the accompanying drawings, the same or similar reference numerals denote the same or similar elements, in which:

FIG. 1 is a schematic diagram of an example environment in which some embodiments of the present disclosure can be implemented;

FIG. 2 is a flowchart of a method for generating an image according to some embodiments of the present disclosure;

FIG. 3 is a schematic diagram of generating a high-resolution image by using an image generation system according to some embodiments of the present disclosure;

FIG. 4 is a schematic diagram of performing pre-processing on a low-resolution image by using an image pre-processing model according to some embodiments of the present disclosure;

FIG. 5 is a schematic diagram of determining super-resolution parameters and an adjustment size by using an intelligent quality sensing and adjustment module according to some embodiments of the present disclosure;

FIG. 6 is a schematic diagram of generating a super-resolution image by using a generative super-resolution model according to some embodiments of the present disclosure;

FIG. 7 is a schematic diagram of performing post-processing on a super-resolution image according to some embodiments of the present disclosure;

FIG. 8 is a block diagram of an apparatus for generating an image according to some embodiments of the present disclosure; and

FIG. 9 is a block diagram of an electronic device according to some embodiments of the present disclosure.

Throughout the accompanying drawings, the same or similar reference numerals denote the same or similar elements.

### DETAILED DESCRIPTION OF EMBODIMENTS

It can be understood that the data involved in the technical solutions (including, but not limited to, the data itself and the access to or use of the data) shall comply with the requirements of corresponding laws, regulations, and relevant provisions.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the abovementioned process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may also be included below.

As mentioned above, a super-resolution technology is crucial to the improvement of images and details. In a related art, an image enhancement algorithm based on a generative adversarial network (GAN for short below) has made significant progress, and performs well in producing a high-quality and realistic image. However, given that the essence of the GAN is to learn the distribution laws of data through adversarial training of a generator and a discriminator, there are still some limitations in terms of image enhancement. For example, the GAN is prone to face “dimensionality disasters” when handling high-dimensional data, making it difficult to perform training. In addition, the GAN is prone to lose important information when generating complex textures and details. Moreover, it is often difficult for the GAN to maintain consistent performance when handling images of different styles. These limitations limit the GAN's ability to continuously improve picture quality of an image in terms of image enhancement.

To this end, embodiments of the present disclosure propose a stable method for improving picture quality. According to embodiments of the present disclosure, by targetedly and flexibly adjusting super-resolution parameters of a generative super-resolution model based on image parameters determined based on an image uploaded by a user and by using output resolution determined by the user, and generating an image with higher resolution using the generative super-resolution model, the method not only improves picture quality of the image, but also ensures good stability and consistency of generated high-resolution images, thereby improving user experience.

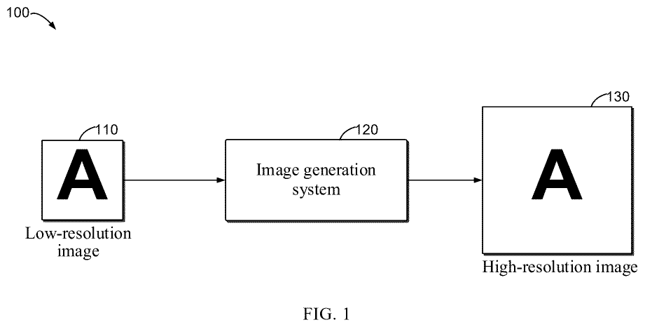

FIG. 1 is a schematic diagram of an example environment 100 in which some embodiments of the present disclosure can be implemented. As shown in FIG. 1, to obtain a high-resolution image, a user may upload a low-resolution image 110 to an image generation system 120, and after processing performed by the image generation system 120, a high-resolution image 130 that is not only larger in size but also richer in detail can be obtained, so that visual viewing experience of the user is significantly improved.

Referring to FIG. 1, in some embodiments, the image generation system 120 may be constructed by using a plurality types of or a plurality of models or modules. In some embodiments, an image pre-processing model may be included to perform pre-processing on the low-resolution image 110, and the image pre-processing model may be a model with a GAN structure, and is capable of performing pre-restoration and reconstruction on the low-resolution image 110 uploaded by the user. In some embodiments, the image pre-processing model may first detect whether a human face is included in the low-resolution image 110 uploaded by the user, and evaluate and score quality of the low-resolution image 110. In some embodiments, if a human face is included, a portrait part containing the human face may be restored before super-resolution pre-processing is performed on the entire image to reconstruct and restore the image. In some embodiments, image parameters determined by the image pre-processing model include a quality score of the image, a category of the image, a parameter for face recognition, and the like.

Still referring to FIG. 1, in some embodiments, in order to enable the generated high-resolution image 130 to have richer details and a more natural image effect, an image may be supplementarily generated by a generative super-resolution model in the image generation system 120. For example, the low-resolution image 110 may be reconstructed and restored using a resolution level selected by the user and the generative super-resolution large model, to ultimately obtain the high-resolution image 130. In some embodiments, the generative super-resolution model may be a diffusion model. With the help of a super-resolution algorithm based on the diffusion model, picture details of the image can be generatively supplemented while semantic information and overall composition consistency are maintained, thereby comprehensively improving the texture and quality of the image.

Still referring to FIG. 1, in some embodiments, in order to enable the high-resolution image 130 generated by the generative super-resolution model to be stabler, an intelligent quality adjustment module in the image generation system 120 may adaptively adjust a size of the image and adjust a parameter for the generative super-resolution model based on image parameters determined by the image pre-processing model and the resolution level selected by the user. In some embodiments, quality of an output image may also be finally determined by using an image post-processing model and output resolution level selected by the user for the generated high-resolution image 130, so that quality performance of the reconstructed image can be further improved. In some embodiments, the image post-processing model may alternatively be a model that contains a GAN structure.

By targetedly and flexibly adjusting a super-resolution parameter of the generative super-resolution model based on image parameters determined based on an image uploaded by the user and by using output resolution determined by the user, and generating an image with higher resolution using the adjusted generative super-resolution model, the method not only improves picture quality of the image, but also ensures good stability and consistency of generated high-resolution images, thereby improving user experience.

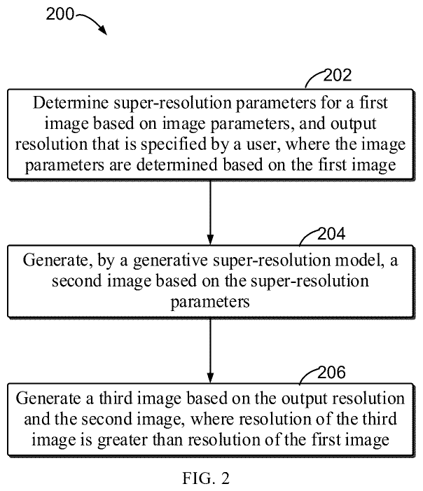

The process according to the embodiments of the present disclosure will be described in detail below in conjunction with FIG. 2 to FIG. 9. For ease of understanding, all the specific data mentioned in the following description is exemplary, and is not intended to limit the scope of protection of the present disclosure. It can be understood that the embodiments described below may further include additional actions not shown and/or may omit actions shown, and the scope of the present disclosure is not limited in this regard.

FIG. 2 is a flowchart of a method 200 for generating an image according to some embodiments of the present disclosure. Referring to FIG. 2, the method 200 includes a block 202, a block 204, and a block 206. The method 200 may be performed by an apparatus for generating an image. The apparatus may be a server, for example, a computing system, a single server, or a distributed server, or may be a system configured in the cloud, or may be a stand-alone apparatus or system. The apparatus may be implemented by using software and/or hardware. The method 200 will be described below with the apparatus for generating an image being an entity of execution.

At the block 202, super-resolution parameters for a first image are determined based on image parameters, and output resolution that is specified by a user, where the image parameters are determined based on the first image. Referring to FIG. 1, in some embodiments, in order to enable the generated high-resolution image 130 to have high fidelity, the generative super-resolution model in the image generation system 120 may be employed to generatively supplement the low-resolution image 110. Meanwhile, in order to ensure that the generated high-resolution image 130 to have high stability and consistency, the image generation system 120 may flexibly adjust a super-resolution parameter of the generative super-resolution model based on image parameters of an image (that is, the first image, where reference may be made to the low-resolution image 110 shown in FIG. 1) uploaded by the user and resolution (for example, 1k, 2k, or 4k) specified by the user for an output image. In some embodiments, the image parameters may be an image quality score, an image category, or the like of the low-resolution image 110 in FIG. 1. In some embodiments, the image parameters herein may also include quality of face recognition for the image.

At the block 204, a second image is generated by the generative super-resolution model based on the super-resolution parameters. Referring to FIG. 1, the second image herein is an intermediate image generated by the image generation system 120 in a process of generating the high-resolution image 130. In some embodiments, the low-resolution image 110 may be generatively supplemented to the second image by the generative super-resolution model based on the determined super-resolution parameters and a level selected by the user for the output image, thereby facilitating the generation of the high-resolution image 130. In some embodiments, the generative super-resolution model may be a diffusion model, and the super-resolution parameters herein may be parameters such as a sampling parameter of the generative super-resolution model or a quantity of motion steps.

At the block 206, a third image is generated based on the output resolution and the second image, where resolution of the third image is greater than resolution of the first image. In some embodiments, referring to FIG. 1, after the generative super-resolution model generates the second image, in order to enable the generated high-resolution image 130 (that is, the third image) to satisfy a selection requirement of the user and have higher quality performance, the second image may be further processed and restored by the image post-processing model in the image generation system 120, so that resolution of the generated high-resolution image 130 is greater than that of the low-resolution image 110, and requirements of different users for resolution of the output image can also be met, thereby improving user experience.

According to the embodiment of the present disclosure, by targetedly and flexibly adjusting a super-resolution parameter of the generative super-resolution model by using image parameters determined based on an image uploaded by the user and by using the output resolution determined by the user, and generating an image with higher resolution using the generative super-resolution model, the method not only improves picture quality of the image, but also ensures good stability of the generated high-resolution image, and requirements of different users for resolution of the output image are also be met, thereby improving user experience.

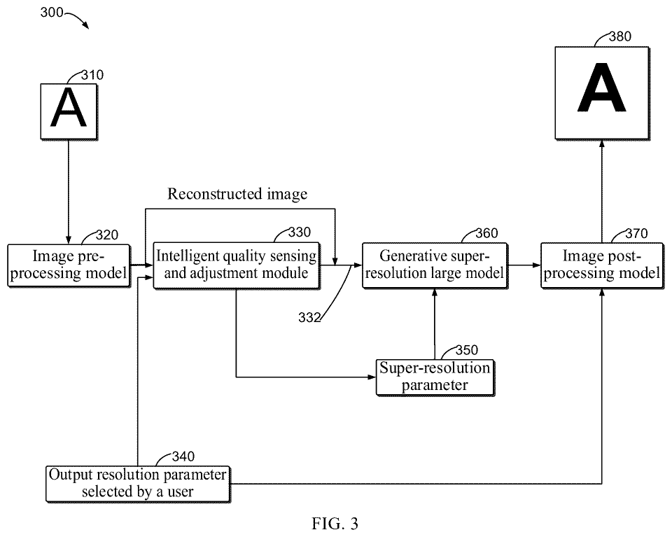

FIG. 3 is a schematic diagram of generating a high-resolution image 300 by using an image generation system according to some embodiments of the present disclosure. Referring to FIG. 3, an image 310 is a low-resolution image, and an image 380 is a high-resolution image with higher resolution than the image 310, featuring richer details and a more natural and smoother image effect. A process of generating the high-resolution image 380 may be implemented using the image generation system 120 shown in FIG. 1. The image generation system 120 shown in FIG. 1 may include an image pre-processing model 320, an intelligent quality sensing and adjustment module 330, a generative super-resolution large model 360, an image post-processing model 370, and the like.

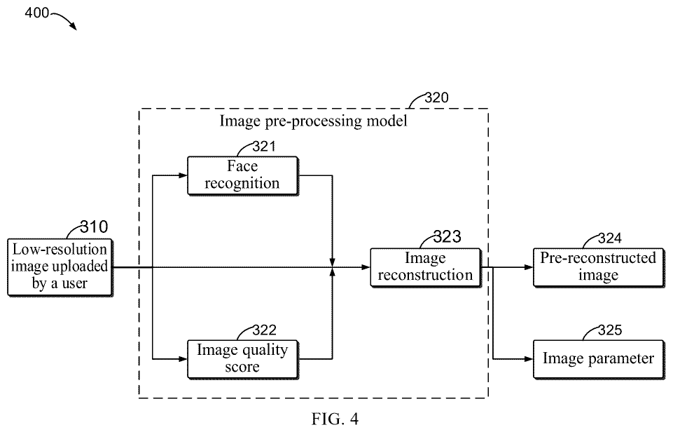

As shown in FIG. 3, in a process of obtaining the final high-resolution image 380, first, the image pre-processing model 320 may perform pre-processing on an image (that is, the image 310) uploaded by a user, which facilitates further processing on the low-resolution image in a subsequent process, and improves processing efficiency. A process of performing pre-processing on an image by using the image pre-processing model will be described below in conjunction with FIG. 4. FIG. 4 is a schematic diagram of performing pre-processing on a low-resolution image 400 by using an image pre-processing model according to some embodiments of the present disclosure. In some embodiments, the image pre-processing model 320 may have a same network structure as a GAN.

Referring to FIG. 4, the low-resolution image 310 (which may be the first image) uploaded by the user is input to the image pre-processing model 320, so that a pre-reconstructed image 324 and image parameters 325 can be obtained. In this process, the image pre-processing model 320 first performs face recognition at 321, that is, automatically recognizes whether a face (for example, a human face) exists in the image and locates a position of the face. In some embodiments, quality of a face region may also be scored upon detection of the face region. In some embodiments, upon detection of the human face, the image pre-processing model 320 may apply a special algorithm to a detected face region to improve quality of an image of this region. In some embodiments, improving the face region may include operations such as eliminating facial imperfections, reducing noise, and enhancing detail clarity. In this way, the aesthetics and authenticity of a portrait can be improved.

Still referring to FIG. 4, the image pre-processing model 320 may further score quality of the image at 322. In some embodiments, the entire image may be comprehensively scored based on a series of preset quality indicators. In some embodiments, these indicators may include clarity, contrast, color saturation, whether noise exits, and the like. In some embodiments, the image pre-processing model 320 may further determine a category of the image, such as portrait, landscape, building, or another type of classification. In this method, overall quality of the image can be quantized, and a reference is provided for subsequent restoration work.

Still referring to FIG. 4, after completing portrait restoration, the image pre-processing model 320 may reconstruct the image at 323, that is, super-resolution pre-processing may be performed on the entire image to obtain a pre-restored image. In this way, subsequent further image restoration by the generative super-resolution model can be facilitated. After the image pre-processing model 320 performs pre-processing on the low-resolution image 310 uploaded by the user, a pre-reconstructed image 324 and the image parameters 325 may be output, where the image parameters 325 include the image quality score described above, quality of the human face, the category of the image, and a parameter obtained in a face recognition process.

Returning to FIG. 3, after processing performed by the image pre-processing model 320, in order to enable subsequent processing performed by the generative super-resolution large model 360 on the image to be targeted and avoid a phenomenon of instability of the generative super-resolution large model 360 in an image processing process, the intelligent quality sensing and adjustment module 330 may be employed to flexibly determine super-resolution parameters of the generative super-resolution large model 360. In some embodiments, the generative super-resolution large model may be a diffusion model. In some embodiments, considering that the generative super-resolution large model 360 is quite sensitive to a size of the image, before the pre-reconstructed image 324 shown in FIG. 4 is fed into the generative super-resolution large model 360 for processing, an adjustment size for adaptive image adjustment also needs to be determined by the intelligent quality sensing and adjustment module 330.

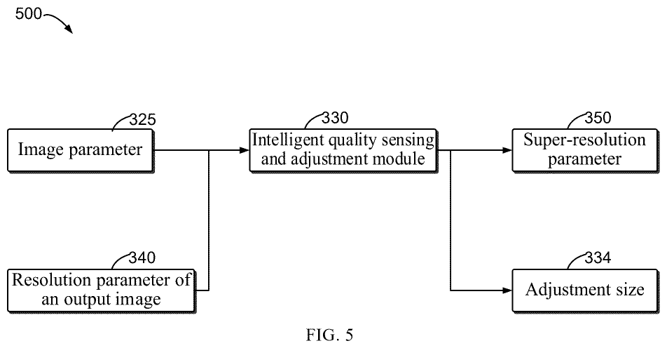

A process of determining the super-resolution parameters and the adjustment size will be described below in conjunction with FIG. 5. FIG. 5 is a schematic diagram of determining super-resolution parameters and an adjustment size 500 by using an intelligent quality sensing and adjustment module according to some embodiments of the present disclosure. In some embodiments, the intelligent quality sensing and adjustment module 330 may be rule-based.

Referring to FIG. 5, in some embodiments, the image parameters 325 obtained after processing performed by the image pre-processing model 320 and a resolution parameter 340 of the output image determined by the user may be input to the intelligent quality sensing and adjustment module 330 to obtain an adjustment size 334 for adjusting the image. In some embodiments, the pre-reconstructed image 324 may be dynamically sized based on the pre-reconstructed image 324 and an image quality score in the image parameters 325, so that it can be convenient for the generative super-resolution large model 360 to receive an input image with a most appropriate size, thereby enabling the generative diffusion super-resolution model to better utilize a restoration capability of the generative diffusion super-resolution model.

Still referring to FIG. 5, in some embodiments, the image parameters 325 obtained after processing performed by the image pre-processing model 320 and a resolution parameter 340 of the output image determined by the user may be input to the intelligent quality sensing and adjustment module 330 to obtain a super-resolution parameter 350 of the generative super-resolution large model that corresponds to the image. For example, an output resolution level (for example, 1k, 2k, or 4k) selected by the user, along with parameters obtained by the pre-processing model 320, such as an image quality score, face recognition, quality of a human face, and an image category, may be input to the intelligent quality sensing and adjustment module 330, to intelligently determine super-resolution parameters used by a diffusion model. These parameters may be parameters such as a sampling manner, a generation capability, a quantity of motion steps, and consistency.

Returning to FIG. 3, a resized image 332 may be obtained based on the adjustment size 334 obtained after processing performed by the intelligent quality adjustment module 330. After the generative super-resolution large model 360 is set with reference to the super-resolution parameters 350 obtained by the intelligent quality adjustment module 330, the resized image 332 may be fed into the generative super-resolution large model 360.

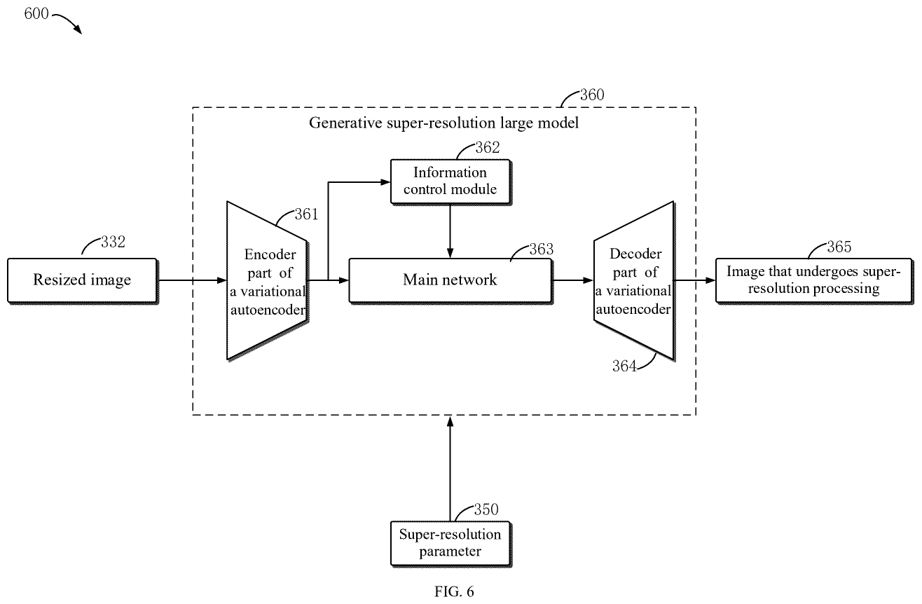

A process of generating a super-resolution image by using a generative super-resolution large model will be described below in conjunction with FIG. 6. FIG. 6 is a schematic diagram of generating a super-resolution image 600 by using a generative super-resolution model according to some embodiments of the present disclosure. In some embodiments, the generative super-resolution model is a diffusion model. Referring to FIG. 6, after the resized image 332 is fed into the generative super-resolution large model 360 adjusted by using the super-resolution parameters 350, low-dimensional encoding may be performed on input image information by using an encoder part 361 of a variational autoencoder (VAE). To be specific, the variational autoencoder 361 processes the image by using a series of convolutional layers, and extracts key features in the image, including basic constituent elements of the image, such as edges, textures, and color.

Still referring to FIG. 6, in some embodiments, the encoder part 361 of the variational autoencoder may compress the extracted features into lower-dimensional space, thereby forming a compact vector representation. This lower-dimensional space is referred to as latent space (latent space), and each vector in the latent space corresponds to a simplified representation of an original image (that is, the resized image 332).

As shown in FIG. 6, image information that undergoes low-dimensional encoding may be fed into an information control module (condition module) 362 to extract information. In this way, a main network (U-Net) 363 of the generative super-resolution large model 360 can be guided to generate an image. In some embodiments, the information control module 362 may use additional conditioning (conditioning) information to guide the generative super-resolution large model 360 to generate an image. In some embodiments, the information control module 362 adopts a network architecture similar to that of the variational autoencoder 361, such as a variational autoencoder (VAE), a conditional variational autoencoder (cVAE), or another similar model. This ensures that a scale between network layers of the information control module 362 is consistent with that of the generative super-resolution large model 360, and facilitates the injection of extracted control information, thereby helping enhance overall performance of the generative super-resolution large model 360.

Still referring to FIG. 6, in a process in which the information control module 362 guides the main network 363 to generate an image, a spatial feature transformation (SFT) operation may be used to maintain a high level of consistency between an output image 365 undergoing super-resolution processing and the input resized image 332. This conversion can provide stronger binding force and make the impact of the control information more significant than simple addition of information (directly superimposing the control information on a specific layer of the generative super-resolution large model). In this way, good stability and consistency of the generated super-resolution image can be ensured.

Still referring to FIG. 6, in a process of generating the image 365 that undergoes super-resolution processing, low-dimensional encoding on the image may be iteratively updated in the main network 363 for a plurality of times, and each iterative update is dedicated to optimizing a latent space representation. In some embodiments, a predetermined quantity of iterative updates may be dozens of times, which is specific to precision and computational resources required by the user. When the number of iterative updates reaches a predetermined quantity of times, low-dimensional encoding information may be reconstructed back into image space by a decoder part 364 of the variational autoencoder of the generative super-resolution large model 360, so that the image 365 that undergoes super-resolution processing can be obtained.

This low-dimensional method of generating a high-resolution image not only saves resources needed for training, but also avoids a problem of over-fitting in an image processing process, thereby improving the stability and consistency in an image generation process.

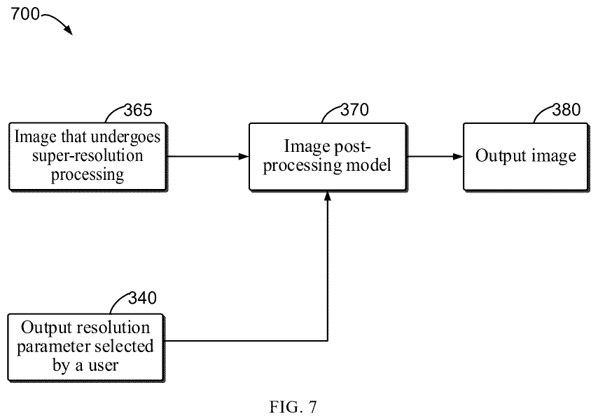

Returning to FIG. 3, after the image 365 that undergoes super-resolution processing is obtained, the image may also be further processed by an image post-processing model 370 to obtain a high-quality and high-resolution image 380. This process will be described below in conjunction with FIG. 7. FIG. 7 is a schematic diagram of performing post-processing 700 on a super-resolution image according to some embodiments of the present disclosure. Referring to FIG. 7, the image 365 that undergoes super-resolution processing and the parameter 340 of the output resolution selected by the user are fed into the image post-processing model 370, so that a final high-resolution image 380 that matches an output level selected by the user can be obtained. It can be understood that output image quality of a 4k level>image quality of a 2k level>image quality of a 1080p level. In addition, consumed processing time of the 1080p level<consumed processing time of the 2k level<consumed processing time of the 4k level. In some embodiments, the image post-processing model 370 may be a model with a network structure of a GAN.

In this way, it is possible to generate resolution level pictures of various output effects in the case of different resolution parameters, thereby satisfying requirements of different users, and improving user experience.

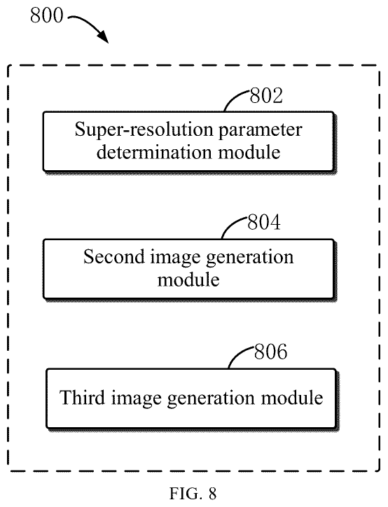

FIG. 8 is a block diagram of an apparatus 800 for generating an image according to some embodiments of the present disclosure. As shown in FIG. 8, the apparatus 800 includes a super-resolution parameter determination module 802 configured to determine super-resolution parameters for a first image based on image parameters, and output resolution that is specified by a user, where the image parameters are determined based on the first image. The apparatus 800 further includes a second image generation module 804 configured to generate, by a generative super-resolution model, a second image based on the super-resolution parameters. The apparatus 800 further includes a third image generation module 806 configured to generate a third image based on the output resolution and the second image, where resolution of the third image is greater than resolution of the first image.

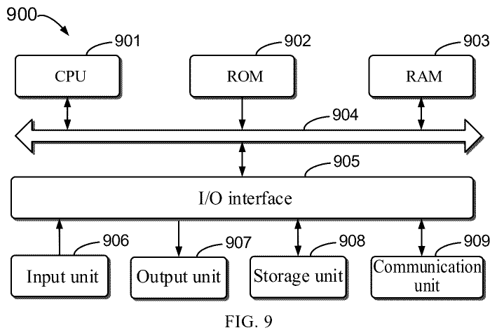

FIG. 9 is a block diagram of an electronic device 900 according to some embodiments of the present disclosure. The device 900 may be a device or an apparatus described in the embodiments of the present disclosure. As shown in FIG. 9, the device 900 includes a central processing unit (CPU) and/or graphics processing unit (GPU) 901 that may perform a variety of appropriate actions and processing in accordance with computer program instructions stored in a read-only memory (ROM) 902 or computer program instructions loaded from a storage unit 908 into a random-access memory (RAM) 903. The RAM 903 may further store various programs and data required for the operation of the device 900. The CPU/GPU 901, the ROM 902, and the RAM 903 are connected to each other via a bus 904. An input/output (I/O) interface 905 is also connected to the bus 904. Although not shown in FIG. 9, the device 900 may further include a coprocessor.

A number of components in the device 900 are connected to the I/O interface 905, including: an input unit 906, such as a keyboard or a mouse; an output unit 907, such as various types of displays or speakers; the storage unit 908, such as a magnetic disk or an optical disk; and a communication unit 909, such as a network card, a modem, or a wireless communication transceiver. The communication unit 909 allows the device 900 to exchange information/data with other devices over a computer network such as the Internet and/or various telecommunication networks.

Each method or process described above may be performed by the CPU/GPU 901. For example, in some embodiments, the method may be implemented as a computer software program tangibly embodied in a machine-readable medium, such as the storage unit 908. In some embodiments, some or all of the computer programs may be loaded into and/or installed onto the device 900 via the ROM 902 and/or the communication unit 909. When the computer program is loaded into the RAM 903 and executed by the CPU/GPU 901, one or more steps or actions in the method or process described above may be performed.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions tokenized in the blocks may occur in a sequence different from that tokenized in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed herein.

Some example implementations of the present disclosure are listed below.

Example 1. A method for generating an image, comprising:
determining super-resolution parameters for a first image based on image parameters, and output resolution that is specified by a user, the image parameters being determined based on the first image;
generating, by a generative super-resolution model, a second image based on the super-resolution parameters; and
generating a third image based on the output resolution and the second image, resolution of the third image being greater than resolution of the first image.

Example 2. The method according to Example 1, further comprising:
obtaining the first image uploaded by the user; and
determining, by an image pre-processing model, a quality evaluation score and an image category for the first image based on the first image, the image parameters comprising the quality evaluation score and the image category.

Example 3. The method according to either of Examples 1 and 2, further comprising:
determining, by the image pre-processing model, whether a face exists in the first image based on the first image; and
determining, by the image pre-processing model and in response to detecting that a face exists in the first image, image quality of the face.

Example 4. The method according to any one of Examples 1 to 3, further comprising:
reconstructing, by the image pre-processing model, the first image based on the first image, the quality evaluation score, and the image quality of the face.

Example 5. The method according to any one of Examples 1 to 4, further comprising:
determining an adjustment size for a reconstructed first image based on the image parameters and the output resolution; and
adjusting the reconstructed first image based on the adjustment size.

Example 6. The method according to any one of Examples 1 to 5, where the generating, by a generative super-resolution model, a second image based on the super-resolution parameters comprises:
performing, by an encoder of the generative super-resolution model, dimensionality reduction encoding on the first image to obtain image encoding information for the first image;
extracting, by an information control module of the generative super-resolution model, the image encoding information, the information control module and the encoder having a similar network structure; and
generating, by a main network of the generative super-resolution model, the second image based on the extracted image encoding information.

Example 7. The method according to any one of Examples 1 to 6, where the generating, by a main network of the generative super-resolution model, the second image based on the extracted image encoding information comprises:
injecting the extracted image encoding information into the image encoding information in the main network through spatial feature transformation; and
updating the second image iteratively based on the main network.

Example 8. The method according to any one of Examples 1 to 7, further comprising:
determining whether a number of iterative updates for the second image meets a predetermined condition; and
reconstructing, by a decoder of the generative super-resolution model, image encoding information of the second image that meets the predetermined condition back to image space, to obtain the second image, in response to detecting that the number of iterative updates meets the predetermined condition.

Example 9. The method according to any one of Examples 1 to 8, where the generating the third image based on the output resolution and the second image comprises:
generating, by an image post-processing model, the third image based on the second image and the output resolution.

Example 10. An apparatus for generating an image, comprising:
a super-resolution parameter determination module configured to determine super-resolution parameters for a first image based on image parameters, and output resolution that is specified by a user, the image parameters being determined based on the first image;
a second image generation module configured to generate, by a generative super-resolution model, a second image based on the super-resolution parameters; and
a third image generation module configured to generate a third image based on the output resolution and the second image, resolution of the third image being greater than resolution of the first image.

Example 11. The apparatus according to Example 10, further comprising:
a first image obtaining module configured to obtain the first image uploaded by the user; and
a first determining module configured to determine, by an image pre-processing model, a quality evaluation score and an image category for the first image based on the first image, the image parameters comprising the quality evaluation score and the image category.

Example 12. The apparatus according to either of Examples 10 and 11, further comprising:
a second determining module configured to determine, by the image pre-processing model, whether a face exists in the first image based on the first image; and
a third determining module configured to determine, by the image pre-processing model and in response to detecting that a face exists in the first image, image quality of the face.

Example 13. The apparatus according to any one of Examples 10 to 12, further comprising:
a reconstruction module configured to reconstruct, by the image pre-processing model, the first image based on the first image, the quality evaluation score, and the image quality of the face.

Example 14. The apparatus according to any one of Examples 10 to 13, further comprising:
a first adjustment module configured to determine an adjustment size for a reconstructed first image based on the image parameters and the output resolution; and
a second adjustment module configured to adjust the reconstructed first image based on the adjustment size.

Example 15. The apparatus according to any one of Examples 10 to 14, where the second image generation module comprises:
a dimensionality reduction module configured to perform, by an encoder of the generative super-resolution model, dimensionality reduction encoding on the first image to obtain image encoding information for the first image;
an extraction module configured to extract, by an information control module of the generative super-resolution model, the image encoding information, the information control module and the encoder having a similar network structure; and
a first generation module configured to generate, by a main network of the generative super-resolution model, the second image based on the extracted image encoding information.

Example 16. The apparatus according to any one of Examples 10 to 15, where the generation module comprises:
an injection module configured to inject the extracted image encoding information into the image encoding information in the main network through spatial feature transformation; and
an updating module configured to update the second image iteratively based on the main network.

Example 17. The apparatus according to any one of Examples 10 to 16, further comprising:
a fourth determining module configured to determine whether a number of iterative updates for the second image meets a predetermined condition; and
a reconstruction module configured to reconstruct, by a decoder of the generative super-resolution model, image encoding information of the second image that meets the predetermined condition back to image space, to obtain the second image, in response to detecting that the number of iterative updates meets the predetermined condition.

Example 18. The apparatus according to any one of Examples 10 to 17, where the third image generation module comprises:
a second generation module configured to generate, by an image post-processing model, the third image based on the second image and the output resolution.

Example 19. An electronic device, comprising:
a processor; and
a memory coupled to the processor, where the memory has stored therein instructions that, when executed by the processor, cause the electronic device to perform actions comprising:
determining super-resolution parameters for a first image based on image parameters, and output resolution that is specified by a user, the image parameters being determined based on the first image;
generating, by a generative super-resolution model, a second image based on the super-resolution parameters; and
generating a third image based on the output resolution and the second image, resolution of the third image being greater than resolution of the first image.

Example 20. The electronic device according to Example 19, where the actions further comprise:
obtaining the first image uploaded by the user; and
determining, by an image pre-processing model, a quality evaluation score and an image category for the first image based on the first image, the image parameters comprising the quality evaluation score and the image category.

Example 21. The electronic device according to either of Examples 19 and 20, where the actions further comprise:
determining, by the image pre-processing model, whether a face exists in the first image based on the first image; and
determining, by the image pre-processing model and in response to detecting that a face exists in the first image, image quality of the face.

Example 22. The electronic device according to either of Examples 19 and 21, where the actions further comprise:
reconstructing, by the image pre-processing model, the first image based on the first image, the quality evaluation score, and the image quality of the face.

Example 23. The electronic device according to any one of Examples 19 to 22, where the actions further comprise:
determining an adjustment size for a reconstructed first image based on the image parameters and the output resolution; and
adjusting the reconstructed first image based on the adjustment size.

Example 24. The electronic device according to any one of Examples 19 to 23, where the generating, by a generative super-resolution model, a second image based on the super-resolution parameter comprises:
performing, by an encoder of the generative super-resolution model, dimensionality reduction encoding on the first image to obtain image encoding information for the first image;
extracting, by an information control module of the generative super-resolution model, the image encoding information, the information control module and the encoder having a similar network structure; and
generating, by a main network of the generative super-resolution model, the second image based on the extracted image encoding information.

Example 25. The electronic device according to any one of Examples 19 to 24, where the generating, by a main network of the generative super-resolution model, the second image based on the extracted image encoding information comprises:
injecting the extracted image encoding information into the image encoding information in the main network through spatial feature transformation; and
updating the second image iteratively based on the main network.

Example 26. The electronic device according to any one of Examples 19 to 25, where the actions further comprise:
determining whether a number of iterative updates for the second image meets a predetermined condition; and
reconstructing, by a decoder of the generative super-resolution model, image encoding information of the second image that meets the predetermined condition back to image space, to obtain the second image, in response to detecting that the number of iterative updates meets the predetermined condition.

Example 27. The electronic device according to any one of Examples 19 to 26, where the generating the third image based on the output resolution and the second image comprises:
generating, by an image post-processing model, the third image based on the second image and the output resolution.

Example 28. A computer-readable storage medium having stored thereon computer-executable instructions, where the computer executable instructions are executed by a processor to implement the method according to any one of Examples 1 to 9.

Example 29. A computer program product tangibly stored on a computer-readable medium and comprising computer-executable instructions that, when executed by a device, cause the device to perform the method according to any one of Examples 1 to 9.

Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for generating an image, comprising:
determining super-resolution parameters for a first image based on image parameters, and output resolution that is specified by a user, the image parameters being determined based on the first image;
generating, by a generative super-resolution model, a second image based on the super-resolution parameters; and
generating a third image based on the output resolution and the second image, resolution of the third image being greater than resolution of the first image.

2. The method according to claim 1, further comprising:
obtaining the first image uploaded by the user; and
determining, by an image pre-processing model, a quality evaluation score and an image category for the first image based on the first image, the image parameters comprising the quality evaluation score and the image category.

3. The method according to claim 2, further comprising:
determining, by the image pre-processing model, whether a face exists in the first image based on the first image; and
determining, by the image pre-processing model and in response to detecting that a face exists in the first image, image quality of the face.

4. The method according to claim 3, further comprising:
reconstructing, by the image pre-processing model, the first image based on the first image, the quality evaluation score, and the image quality of the face.

5. The method according to claim 4, further comprising:
determining an adjustment size for a reconstructed first image based on the image parameters and the output resolution; and
adjusting the reconstructed first image based on the adjustment size.

6. The method according to claim 5, wherein the generating, by a generative super-resolution model, a second image based on the super-resolution parameters comprises:
performing, by an encoder of the generative super-resolution model, dimensionality reduction encoding on the first image to obtain image encoding information for the first image;
extracting, by an information control module of the generative super-resolution model, the image encoding information, the information control module and the encoder having a similar network structure; and
generating, by a main network of the generative super-resolution model, the second image based on the extracted image encoding information.

7. The method according to claim 6, wherein the generating, by a main network of the generative super-resolution model, the second image based on the extracted image encoding information comprises:
injecting the extracted image encoding information into the image encoding information in the main network through spatial feature transformation; and
updating the second image iteratively based on the main network.

8. The method according to claim 7, further comprising:
determining whether a number of iterative updates for the second image meets a predetermined condition; and
reconstructing, by a decoder of the generative super-resolution model, image encoding information of the second image that meets the predetermined condition back to image space, to obtain the second image, in response to detecting that the number of iterative updates meets the predetermined condition.

9. The method according to claim 1, wherein the generating the third image based on the output resolution and the second image comprises:
generating, by an image post-processing model, the third image based on the second image and the output resolution.

10. An electronic device, comprising:
a processor; and
a memory coupled to the processor, wherein the memory has stored therein instructions that, when executed by the processor, cause the electronic device to:
determine super-resolution parameters for a first image based on image parameters, and output resolution that is specified by a user, the image parameters being determined based on the first image;
generate, by a generative super-resolution model, a second image based on the super-resolution parameters; and
generate a third image based on the output resolution and the second image, resolution of the third image being greater than resolution of the first image.

11. The device according to claim 10, further comprising instructions causing the processor to:
obtain the first image uploaded by the user; and
determine, by an image pre-processing model, a quality evaluation score and an image category for the first image based on the first image, the image parameters comprising the quality evaluation score and the image category.

12. The device according to claim 11, further comprising instructions causing the processor to:
determine, by the image pre-processing model, whether a face exists in the first image based on the first image; and
determine, by the image pre-processing model and in response to detecting that a face exists in the first image, image quality of the face.

13. The device according to claim 12, further comprising instructions causing the processor to:
reconstruct, by the image pre-processing model, the first image based on the first image, the quality evaluation score, and the image quality of the face.

14. The device according to claim 13, further comprising instructions causing the processor to:
determine an adjustment size for a reconstructed first image based on the image parameters and the output resolution; and
adjust the reconstructed first image based on the adjustment size.

15. The device according to claim 14, wherein the instructions causing the processor to generate, by a generative super-resolution model, a second image based on the super-resolution parameters comprise instructions causing the processor to:
perform, by an encoder of the generative super-resolution model, dimensionality reduction encoding on the first image to obtain image encoding information for the first image;
extract, by an information control module of the generative super-resolution model, the image encoding information, the information control module and the encoder having a similar network structure; and
generate, by a main network of the generative super-resolution model, the second image based on the extracted image encoding information.

16. The device according to claim 15, wherein the instructions causing the processor to generate, by a main network of the generative super-resolution model, the second image based on the extracted image encoding information comprise instructions causing the processor to:
inject the extracted image encoding information into the image encoding information in the main network through spatial feature transformation; and
update the second image iteratively based on the main network.

17. The device according to claim 16, further comprising instructions causing the processor to:
determine whether a number of iterative updates for the second image meets a predetermined condition; and
reconstruct, by a decoder of the generative super-resolution model, image encoding information of the second image that meets the predetermined condition back to image space, to obtain the second image, in response to detecting that the number of iterative updates meets the predetermined condition.

18. The device according to claim 10, wherein the instructions causing the processor to generate the third image based on the output resolution and the second image comprise instructions causing the processor to:
generate, by an image post-processing model, the third image based on the second image and the output resolution.

19. A non-transitory computer-readable medium comprising instructions stored thereon which, when executed by a processor, cause the processor to:
determine super-resolution parameters for a first image based on image parameters, and output resolution that is specified by a user, the image parameters being determined based on the first image;
generate, by a generative super-resolution model, a second image based on the super-resolution parameters; and
generate a third image based on the output resolution and the second image, resolution of the third image being greater than resolution of the first image.

20. The non-transitory computer-readable medium according to claim 19, further comprising instructions causing the processor to:
obtain the first image uploaded by the user; and
determine, by an image pre-processing model, a quality evaluation score and an image category for the first image based on the first image, the image parameters comprising the quality evaluation score and the image category.
